(19) United States
(12) Patent Application Publication
(10) Pub. No.: US 2002/0016820 A1
(43) Pub. Date: Feb. 7, 2002

(54) Distributing datacast signals embedded in broadcast transmissions over a computer network

(76) Inventors: Jordan Du Val, Santa Clara, CA (US); Wen Li, Pleasanton, CA (US)

Correspondence Address: Brain D. Ogonowsky, SKJERVEN MORRILL MacPHERSON LLP, Suite 700, 25 Metro Drive, San Jose, CA, 95110-1349, US

(21) Appl. No.: 09/965,593

(22) Filed: Sep. 25, 2001

Related U.S. Application Data
(63) Continuation-in-part of application No. 09/585,266, filed on May 30, 2000.

(51) Int. Cl. H04N 7/173

(52) U.S. Cl. 709/203; 725/112

(57) ABSTRACT

A system and method for distributing in real-time interactive data extracted from a video signal to a plurality of client computers via a computer network. A plurality of data source computers extract the interactive data from the video signals, and forward them to a distribution server. The distribution server buffers the interactive data and broadcasts the interactive data to a Web server cluster. A program executing on each client computer periodically sends updation requests to the Web server cluster to retrieve new interactive data for display to the user. A re-direct server receives a user request for access to a remote computer resource identified in the interactive data, and re-directs the user request to the remote computer resource. A computer program operating within a Web server and the distribution server further enables script files containing additional interactive data to be created and processed by the system.

### CROSS-REFERENCE TO RELATED APPLICATION

This application is a continuation-in-part of the U.S. application entitled “PERSONAL COMPUTER USED IN CONJUNCTION WITH TELEVISION TO DISPLAY INFORMATION RELATED TO TELEVISION PROGRAMMING,” Ser. No. 09/585,266, filed on May 30, 2000, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all

### CROSS-REFERENCE TO CD-ROM APPENDIX AND APPENDIX A

CD-ROM Appendix A, which is part of the present disclosure, is a CD-ROM appendix consisting of 430 files. CD-ROM Appendix A is a computer program listing appendix that includes a software program. The total number of compact disks including duplicates is two. Appendix B, which is part of the present specification, contains a list of the files contained on the compact disk. Appendix A and Appendix B are incorporated herein by reference. The attached CD-ROM Appendix A is formatted for an IBM-PC operating a Windows operating system.

### FIELD OF THE INVENTION

This invention relates to interactive audio and visual entertainment, such as live or recorded interactive television programming, and other interactive audio and video content. In particular, this invention relates to systems and methods for distributing interactive data extracted from audio-visual content to a plurality of users over a computer network.

### BACKGROUND

The distribution of enhanced television content to a plurality of users via commercially available set top boxes is known. In one system, a set top box is connected to a television and to the Internet. The set top box receives signals embedded in the television signal's vertical blanking interval (VBI) and extracts the enhanced television content encoded in the signals. The signals may be in accordance with the Advanced Television Enhancement Forum (ATVEF) Enhanced Content Specification, a well-known industry standard. (Additional information relating to ATVEF standards may be obtained from the Internet at http://www.atvef.com.) In a typical application, the enhanced television content includes a URL identifying the location of a computer resource on the Internet-typically a remote server system-along with a short description, such as a text label, of the information and processing supported by the computer resource. The enhanced television content is generally synchronized with the television content, such as a commercial advertisement, and thus provides access via the Internet to supplemental information and processes relating to the television content (hereafter, “supplemental processing”) contemporaneously with the user's viewing of the television content.

FIG. 1 is a time-sequence diagram illustrating the synchronization of interactive data (e.g., enhanced television content) with video content (e.g., television programming) in the prior art. In FIG. 1, portions of a video signal 4 and a stream of interactive data 6 are shown occurring over five time intervals A-E measured over time-line 2. The video signal 4 includes video content 6A and 6B (e.g., a television sit-com), interspersed by three commercial advertisements 8, 10, and 12. A stream of interactive data 6 includes five series of interactive data 0-4 synchronized with the occurrence of the sequence of program content and commercial advertisements 6A, 8, 10, 12, and 6B respectively. Commercial content 2 10, for example, may include a television advertisement for Starbuck's brand coffee 10A occurring over a 30-second interval 16 (time interval C). Interactive data 2 22 synchronized with commercial content 2 10 (time interval C) thus typically relates to the Starbuck's brand of coffee. The enhanced television content 2 22 may thus include the name of the location of a remote computer resource on the Internet, such as “http://www.starbucks.com,” supporting on-line processes supplementing the Starbuck's brand coffee advertisements (e.g., advertisement promotions, e-commerce transactions).

In typical applications, therefore, the set top box extracts a sequence of interactive data from the video signal for display to the user. The user may then select a remote computer resource identified in the interactive data, causing the set top box to access the supplemental processing on the remote computer resource for display to the user on the television.

Although this technique achieves good results, it requires a special set top box or a special television tuner card for use with a personal computer. It is desirable, however, to distribute interactive data embedded in video and audio content to a plurality of users using conventional personal computing devices without additional hardware, including mobile devices which are often limited in expandability. It is also desirable to distribute interactive data using a scalable processing architecture capable of handling synchronous distribution of large volumes of interactive data. This would make the experience of interactive data more convenient for the mobile user as well as reduce the cost of the system for any user.

### SUMMARY

A system and method is described for distributing interactive data extracted from a video signal encoding video content to a plurality of client computers via a computer network. The interactive data is distributed to the user contemporaneously with the user's experience of the encoded video content. In some embodiments, a plurality of data source computers extract the interactive data from the video signals and forward them to a distribution server. In some embodiments, the distribution server buffers the interactive data and broadcasts the interactive data to a Web server cluster. In some embodiments, a program executing on each client computer periodically sends updation requests to the Web server cluster to retrieve new interactive data for display to the user. In some embodiments, a re-direct server receives a user request for access to a remote computer resource identified in the interactive data and re-directs the user request to the remote computer resource. In some embodiments, a computer program operating within a Web server and the distribution server further enables script files containing additional interactive data to be created and processed by the system.

### BRIEF DESCRIPTION OF THE DRAWINGS

FIG. 1 is a time-sequence diagram illustrating interactive data synchronized with a video signal in the prior art.

FIG. 2 is a flow diagram illustrating a method of distributing live data extracted from a video signal to a plurality of client computers, according to some embodiments of the present invention.

FIG. 3 is a screenshot of the distributed live data of FIG. 2 displayed on a client computing device compatible with some embodiments of the present invention.

FIG. 4 is a block diagram illustrating the network components of a System compatible with some embodiments of the present invention.

FIG. 5A is a block diagram illustrating the data flow between the System network components of FIG. 4, according to some embodiments of the present invention.

FIG. 5B is a flow diagram illustrating the process stages of the data flow of FIG. 5A, according to some embodiments of the present invention.

FIG. 6 is a flow diagram illustrating additional process stages performed by the live data source computers, according to some embodiments of the present invention.

FIG. 7 is a block diagram illustrating a data structure for an interactive event compatible with the present invention.

FIGS. 8A-8B illustrate in more detail the logic flow and process stages performed by the distribution server as described in FIG. 5B (stages 158-162), according to some embodiments of the present invention.

FIGS. 9A-9B illustrate in more detail the logic flow and process stages performed by the Web servers in the Web server cluster 104 as described in FIG. 5B (stages 164-166), according to some embodiments of the present invention.

FIG. 10 is a flow diagram illustrating in more detail the process stages performed by the client computer, according to some embodiments of the present invention.

FIG. 11 is a block diagram illustrating the processing of script events in combination with the processing of live events by the System, according to some embodiments of the present invention.

### DETAILED DESCRIPTION

As used herein, “video content” shall refer to content generated during the performance of an audio-visual work. Unless otherwise noted, the term “video content” includes audio-only content (e.g., a radio program), video-only content (e.g., silent motion picture, or a silent motion picture with captions), or any combination of audio-, video-, or other content that one skilled in the art would understand as compatible with the present invention.

As used herein, “live data” is interactive data synchronized with the performance of video content. The interactive data may be extracted from a broadcast transmission, or additionally extracted from a stored medium, such as a DVD, video cassette, or audio recording (note, therefore, that “live data” does not mean a live performance). “Script data” shall refer to interactive data that is not synchronized with the performance of video content.

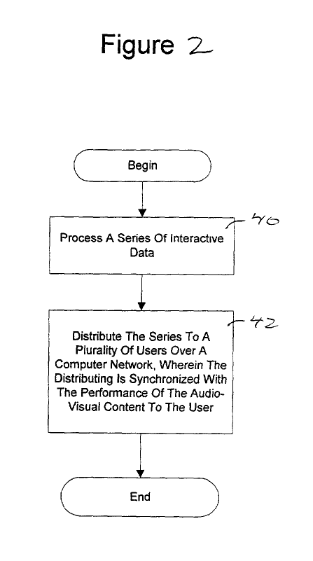

In some embodiments of the present invention, at least one server computer connected to a plurality of client computing devices is programmed to perform the process stages illustrated in FIG. 2. In a first stage 40, the server computer processes a series of live data. In a second stage 42, the server computer distributes the series of live data synchronously to a plurality of client computers over a computer network, such as the Internet. Because the distribution is synchronous, the live data is processed and distributed to the client computing devices within a time period short enough to ensure that the user's experience of the live data (using the client device) is contemporaneous with the user's experience of the video content (the video content being rendered using any conventional content display device, e.g., a television, radio, PDA, computer, including the client computer); in some embodiments, this time period (hereafter “response time”) is no longer than 15 seconds.

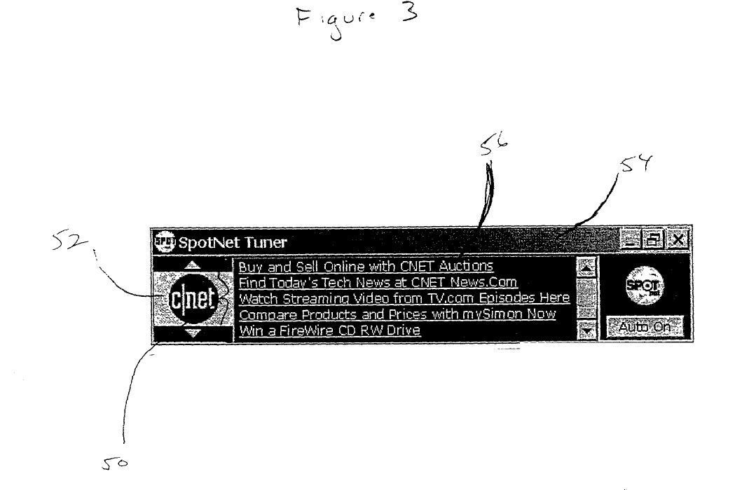

FIG. 3 is a screenshot of the distributed live data of FIG. 2 displayed on a client computing device compatible with some embodiments of the present invention. In this embodiment, the series of interactive data is displayed as a scrolling list of conventional text hyperlinks 50 updated within a window 54. An identification 52, such as a label, icon, or logo, of the carrier of the video content is additionally displayed. Each new live data distributed to a particular client device is distributed by the server computer to the client device as a new text hyperlink, e.g., 56, to be posted in the list 50. The distribution is designed so that the interactive data is posted to the user on the client device within the response time, assuming no occurrence of unrelated processing errors (e.g., a network communication error).

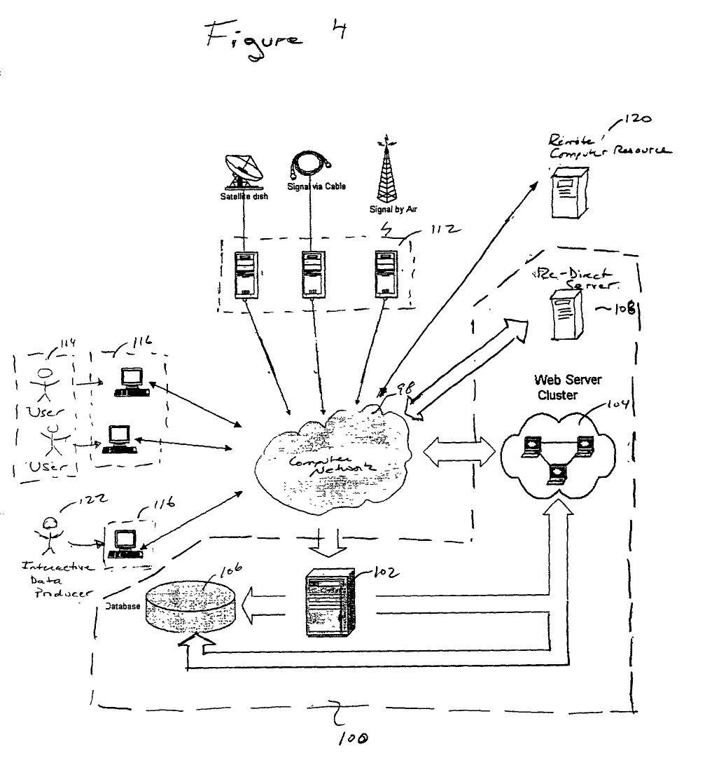

FIG. 4 is a block diagram illustrating the network components of a system compatible with some embodiments of the present invention. In FIG. 4, at least one first server computer 102 is connected to a cluster of second server computers 104, both of which are in turn connected to a third server computer 106 controlling a storage device. The first, second and third server computers 102, 104, and 106 are programmed to process data and instructions comprising the various embodiments of the present invention; the server computers 102, 104, and 106 properly programmed to perform the operations of the various embodiments of the present invention are hereafter referred to as the “distribution server,” “Web server cluster” (or, singly, “Web server”) and “database server” respectively. The terms “distribution server,” “Web server cluster” (or, singly, “Web server”) and “database server” refer herein to the programmed computers, i.e., to both the hardware and software components, unless otherwise stated or implied by context. The “distribution server” 102, “Web server cluster” 104, and “database server” 106 shall be collectively referred to as the “System servers” 100. First, second and third computers 102, 104, and 106 (i.e., “distribution server” 102, “Web server cluster” 104, and “database server” 106 respectively) generally include any conventional general-purpose server computers. In some embodiments, the second computers (hosting the Web server cluster 104) include Supermicro SuperServers 6010H, manufactured by Supermicro, Inc. of San Jose, Calif., equipped with two Intel 700 MHz CPUs, 512 MB of RAM, 9GB SCSI hard drives, and conventional NICs, among other standard components. In some embodiments, the first and third computers include a Caliber CP2700, manufactured by Caliber Corporation of Fremont, Calif., equipped similarly to the Supermicro SuperServer 6010H.

It should be noted that a single computer may be programmed to perform the operations of the distribution server 102, Web server 104, and database server 106, and therefore the latter terms refer primarily to the computational processes constituting the present invention, and not the particular hardware implementation of a subset of such processes. For example, in some embodiments, database server and the distribution server are hosted on the same machine, thus sharing the same processor. It should additionally be noted that by using conventional distributed programming techniques, the number of server computers needed to optimally implement the various embodiments of the present invention will vary depending upon the amount of computer resources required to support the use of the System (i.e., generally a function of the quantity of interactive data processed and distributed to users). In this disclosure, a typical embodiment of the System 100 is described.

System servers 100 are in turn connected to a plurality of computers 112 via computer network 98. The computer network 98 may include the Internet, a local area network (LAN), a wide area network (WAN), a metropolitan area network (MAN), an interactive television network, a wireless network, and generally any other connection capable of delivering electronic content between computer devices. The plurality of computers 112 are programmed to receive video signals from a number of carriers over conventional transmission media (e.g., satellite, cable and air), extract the live data from video signals, and forward the live data in real-time to the distribution server 102. Each carrier may transmit a different video signal for each of a predetermined number of time zones; in some embodiments, one of the plurality of computers 112 will be assigned to receive each of the video signals for the carrier. The plurality of computers 112 programmed in accordance with the present invention are hereafter referred to as “live data sources” or “live data source computers.” The live data sources 112 are implemented using conventional general-purpose computers well-known to those skilled in the art. In particular, each of the plurality of computers 112 are in some embodiments equipped with a conventional Hauppauge TV card for capturing and extracting the interactive data from the live video signal.

System servers 100—in particular, via Web server cluster 104—communicate with a plurality of users 114 operating client computers 116 via computer network 98. Client computers include conventional general-purpose computers typically used by users, such as a standard notebook or desktop computer, as well as more specialized computing devices, such as the various consumer mobile devices (e.g., PDA, cell phone). In general, client computers include any computing device capable of performing data communication with computer resources (network servers) via the computer network 98. Client computers 116 and System servers 104 are additionally connected to a plurality of remote computer resources 120 via computer network 98. Computer resources 120 include, in some embodiments, the millions of remote computer systems interconnected by computer network 98. System servers 100—in particular, via distribution server 102—communicate with at least one non-synchronous interactive data (script data) producer 122 (hereafter, “data producer”) operating one of the plurality of client computers.

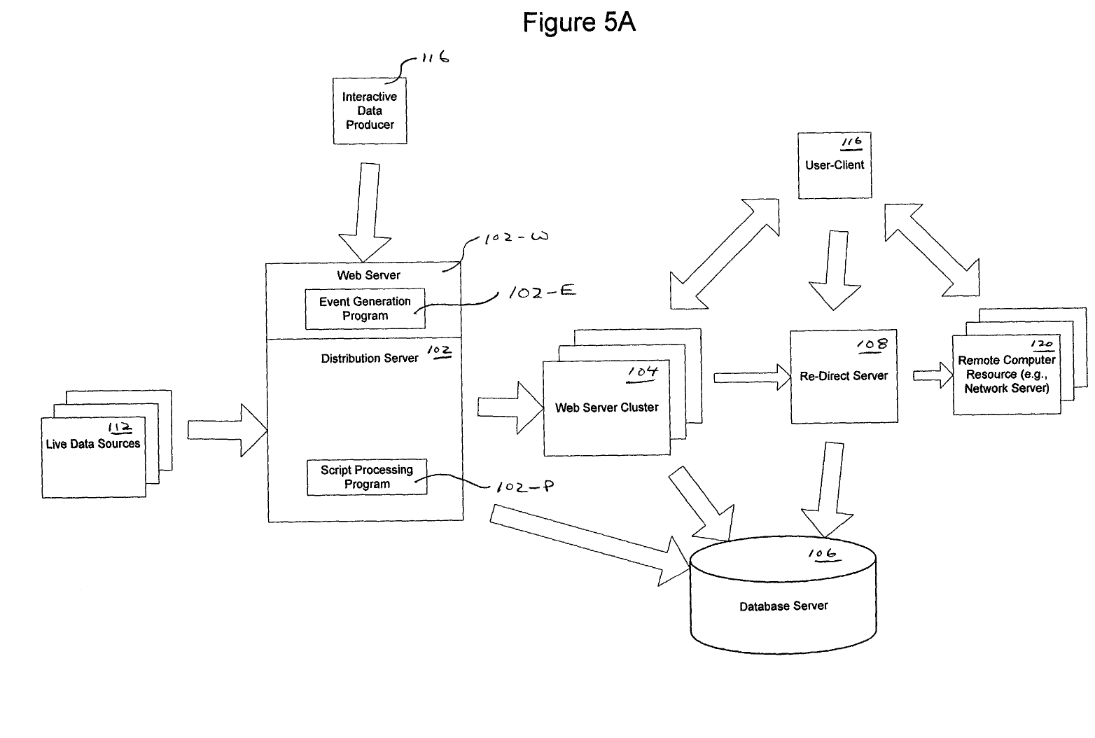

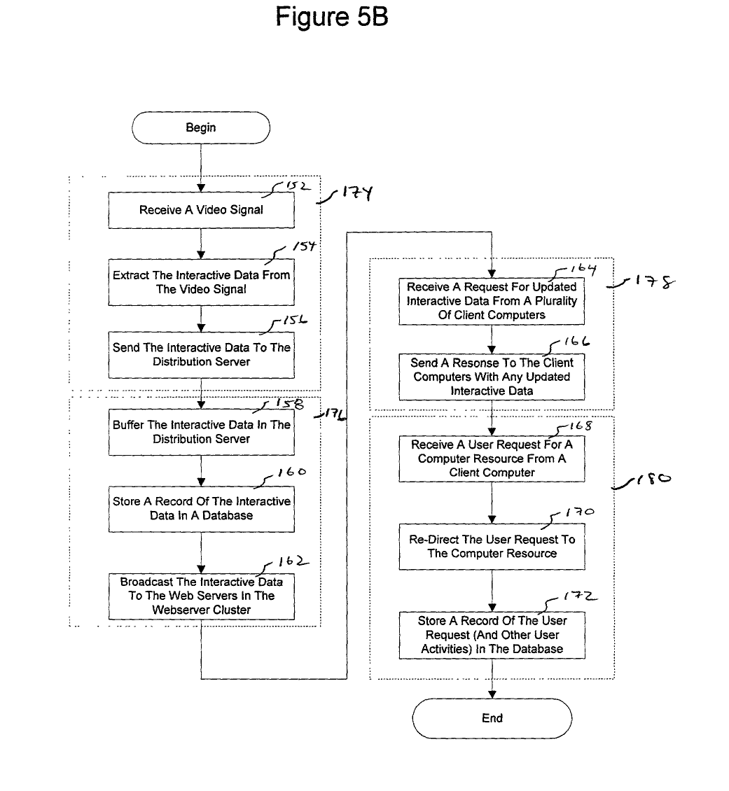

FIGS. 5A and 5B illustrate the data flow within the System 100, according to some embodiments of the present invention. FIG. 5A is a block diagram illustrating the data flow between the System network components of FIG. 4, and FIG. 5B is a flow diagram illustrating the process stages of the data flow of FIG. 5A. The two figures—FIGS. 5A and 5B—are described together. In stage 152, each of the plurality of live data source computers 112 receive a video signal via conventional broadcast transmission (e.g., cable, satellite, air). In stage 154, the live data source computers 112 extract the live data from the video signals, and then (stage 156) forward a stream of the newly extracted live data to the distribution server 102. In stage 158, the distribution server 102 buffers the incoming live data from the data source computers 112. In stage 160, the distribution server 102 stores a record of the incoming live data, and (stage 162) broadcasts the live data to the Web server cluster 104. In stage 164, the Web server cluster 106 receives a plurality of requests for the most current live data (hereafter “updation request”) from a plurality of client computers 116. In stage 166, the Web server cluster 104 processes the updation requests, and sends the most current interactive data to the requesting client computer. In stage 168, the re-direct server 108 receives a plurality of user requests to access a remote computer resource 120. In stage 170, the re-direct server re-directs the user request to the computer resource 120 for processing by the computer resource 120, typically a network server. In stage 172, the re-direct server stores a record of the redirected user request in the database server 106. As illustrated by dotted boxes 174-180, the various stages within each of the dotted boxes are performed by the live data source computers 112, distribution server 102, Web server cluster 104, and remote computer resources 120 respectively.

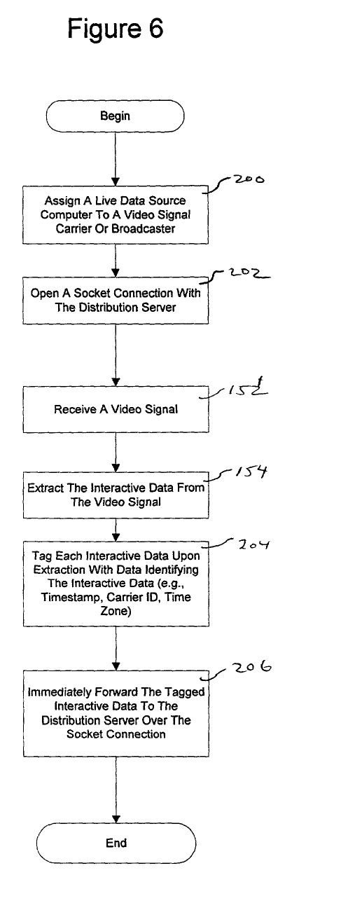

FIG. 6 is a flow diagram illustrating additional process stages performed by the live data source computers 112, according to some embodiments of the present invention. Prior to performing the process stages described in box 174, each local data source computer 112 in stage 202 opens a conventional socket connection using an available predetermined port with the distribution server 102 over computer network 98. The live event 220 is forwarded to the distribution server 102 using a customized application-level protocol—instead of the conventional HTTP—built on top of the conventional TCP transport protocol. A customized protocol is used to maximize the throughput and bandwidth for forwarding the interactive events to the distribution server by avoiding excessive processing overhead arising from the use of the HTTP protocol. For example, because HTTP is generally designed by default to close the socket link after each data transfer, processing time (and therefore communication bandwidth) is wasted by having to re-open the socket link after each data transfer, or by having to execute an additional instruction to keep the socket link open.

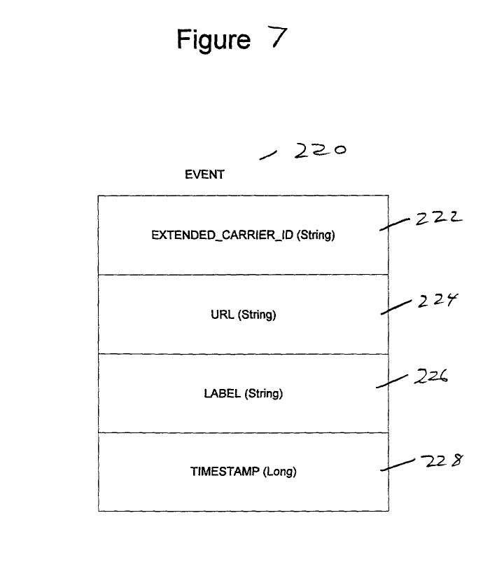

In some embodiments, the live data source computer 112 then performs stages 152-154 as described in FIG. 5B. In the next stage (stage 204), the local data source tags each live data extracted from a video signal with data uniquely identifying each live data; in some embodiments, this additional identifying data includes a timestamp and an extended carrier ID which uniquely identifies the respective carrier of the video signal, and the time zone to which the video signal is directed. As a result of the tagging performed in stage 204, a data structure is created using the interactive data; the data structure thus created is hereafter referred to as an “interactive event” or an “event.” FIG. 7 is a block diagram illustrating a data structure for an event compatible with the present invention. In some embodiments, the event 220 data structure includes an extended_carrier_ID 222, a URL 224, a label 226 typed as strings, and a timestamp 228 typed as a long integer. After the live data source computer 112 constructs each extracted live data into a live interactive event 220 (“live event”), the live data source computer 112 immediately forwards the live event 220 to the distribution computer over the opened socket connection.

In some embodiments, the processes used for capturing and forwarding the interactive events executing on the live data source computers 112 are coded in C, compiled and run as a stand-alone application within a Red Hat Linux operating environment (Red Hat Linux V6.2) well-known to those skilled in the art. (The Red Hat Linux operating system is manufactured by Red Hat Corporation of Durham, N.C.)

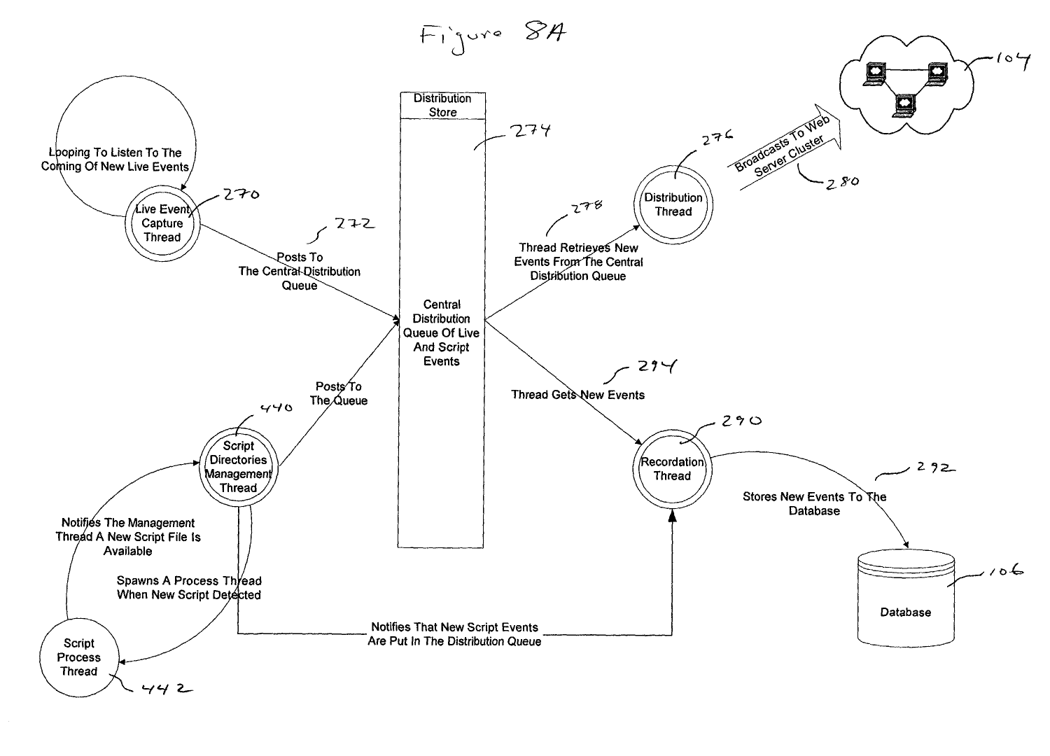

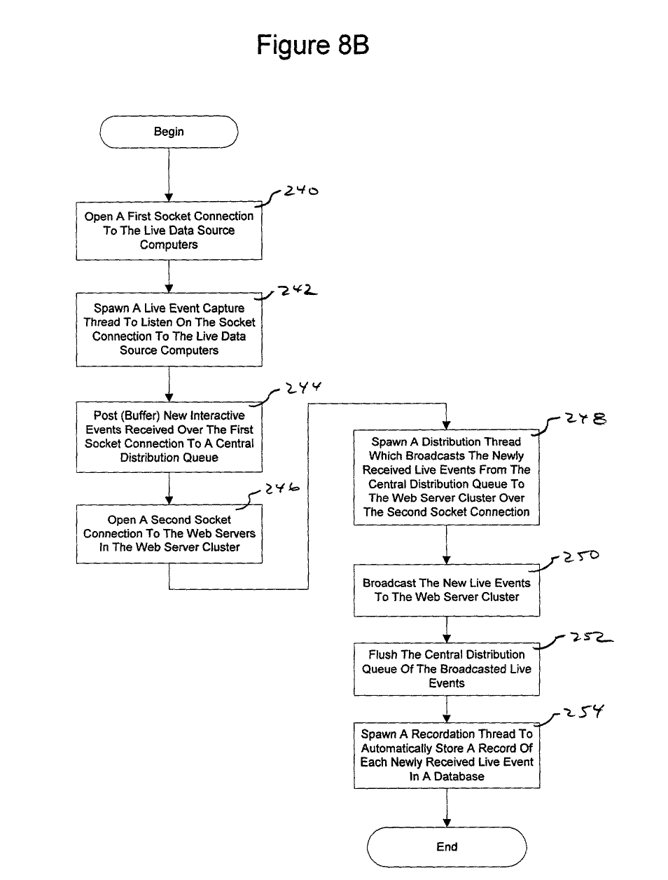

FIGS. 8A-8B illustrate in more detail the logic flow and process stages performed by the distribution server 102 as described in FIG. 5B (stages 158-162), according to some embodiments of the present invention. In stage 240, the distribution server 102 opens a first socket connection (in some embodiments, over port 2000) to each of the live data source computers 112. In stage 242, the distribution server spawns a live event capture thread 270 to listen on the first socket connection for new live events 220 received from the data source computers 112. In stage 244, the distribution server 102 posts (buffers) 272 the new live events 220 to a central distribution queue 274. In stage 246, the distribution server 102 opens a second socket connection (in some embodiments, over port 2001) to the Web server cluster 104. In stage 248, the distribution server 102 spawns a distribution thread 276 which periodically retrieves 278 the new live events 220 (and script events, which are discussed below in reference to FIGS. 5A and 12) from the central distribution queue 274 for broadcasting 280 over the second socket connection to the Web server cluster 104. In stage 250, the distribution server broadcasts the live events (and script events as described in reference to FIG. 5A and 13) to the Web server in the Web server cluster 106 over the second socket connection opened in stage 244.

In some embodiments, the live events are broadcast over the socket connection using the same customized application protocol used for communications between the distribution server 102 and the live data source computers 112 (described in reference to FIG. 6, stage 202). The customized protocol provides more efficient communication of events to the Web server cluster 104 than is obtainable using standard HTTP, which is critical for enabling the System 100 to distribute events within the desired response time. In stage 252, the distribution server 102 flushes the central distribution queue of the events broadcast in the previous stage (250). In stage 254, the distribution server 102 spawns a recordation thread to automatically identify 294 new events, and to store 292 a record of each new event in the database server 106. The process stages described in FIG. 8B may be performed in various orders; for example, the distribution server 102 may spawn the threads in stages 242, 248 and 252 in any order during start-up of the System 100. Distribution server 102 provides required efficiency and bandwidth to the System 100 enabling it to distribute large numbers of events to large numbers of user within the required response time. In particular, in some embodiments, live data source computers 112 may be limited in their programming to the transmission of the live events to a single IP address, i.e., a single host computer; in these embodiments, it is overly expensive to reprogram the live data source computers 112 to provide multi-connection capability. In addition, without distribution server 102, each Web server 104 would need to execute processes for listening and receiving data from the multiple live data source computers 112. This added processing requirement will unsatisfactorily slow the ability of the Web servers to efficiently respond to user updation requests within the required response time, especially as usage of the System 100 increases.

In some embodiments, the processes performed by the distribution server 102 are coded in Java, compiled into Java bytecodes, and executed within a Java Virtual Machine well-known to those skilled in the art. In some embodiments, the Java Virtual Machine runs within a Windows 2000 Server operating system also well-known to those skilled in the art.

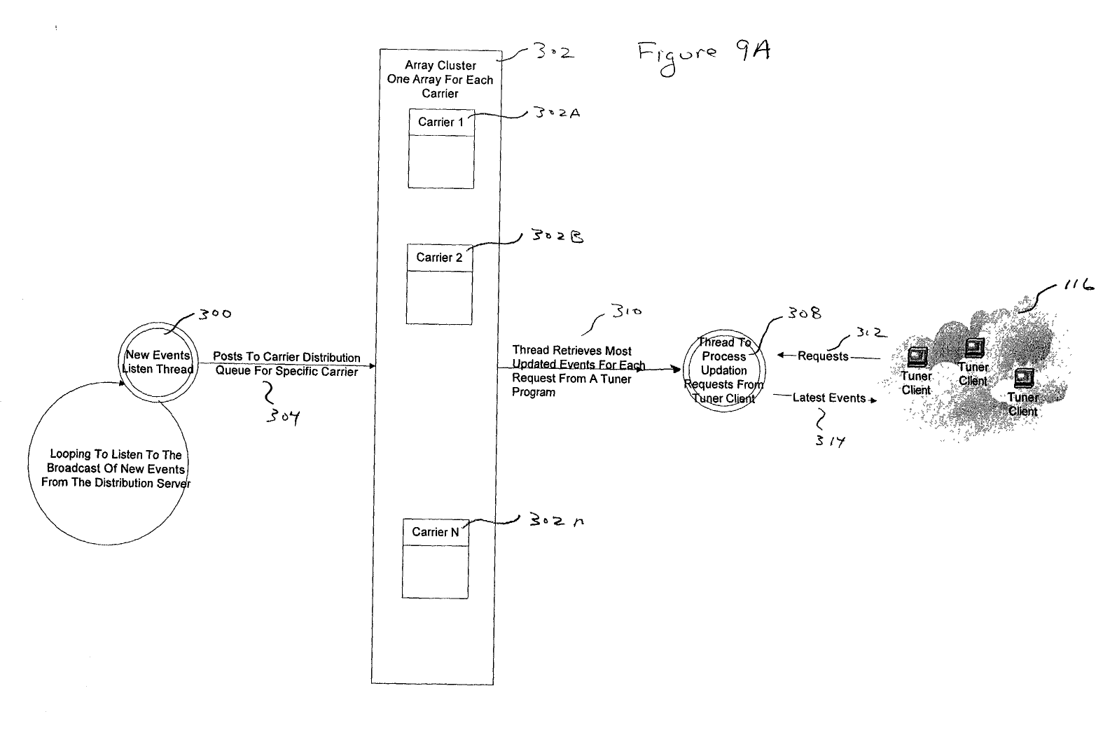

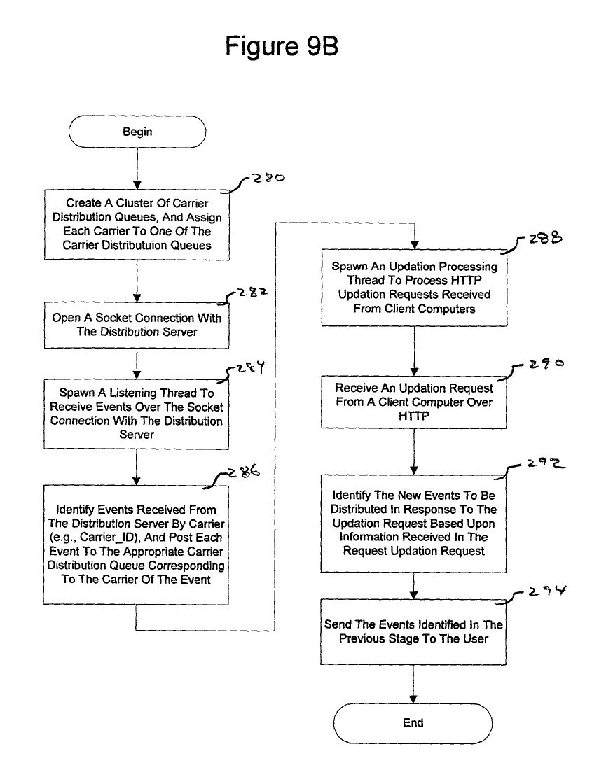

FIGS. 9A-9B illustrate in more detail the logic flow and process stages performed by the Web servers in the Web server cluster 104 as described in FIG. 5B (stages 164-166), according to some embodiments of the present invention. In general, in some embodiments, the Web servers constituting the Web server cluster 104 are programmed similarly to perform the operations described in FIG. 9; thus, although the following process stages are described in reference to a single Web server, they are generally applicable to each Web server in the Web server cluster 104. In stage 280, a cluster 302 of carrier distribution queues 302A-302n are created within the Web server in which a single carrier distribution queue 302A-302n is assigned to each of a predetermined number of times zones for each event carrier (i.e., in some embodiments, one carrier distribution queue is created for each unique extended_carrier_ID). In stage 282, the Web server 104 opens a conventional socket connection (in some embodiments, over port 2001) with the distribution server 282. In stage 284, the Web server spawns a listening thread 300 for receiving new events broadcast over the socket connection from the distribution server 102.

In stage 286, the new events received from the distribution server are identified by carrier and time zone (i.e., extended_carrier_ID), and posted 304 to the appropriate carrier distribution queue 302A-302n (i.e., the queue corresponding to the carrier and time zone of the event). In stage 288, the Web server spawns an updation processing thread 308 to process conventional HTTP (Hyper-text Transport Protocol) requests 312 received from users requesting new events (i.e., updation request). In stage 290, the Web server receives an updation request 312 from a client computer 116, which includes as parameters data identifying a carrier and a time zone (the time zone being retrieved from the cookie file associated with the user), and the timestamp of the most current event received by the tuner. In stage 292, the Web server 104 identifies and retrieves 310 the new events from the relevant carrier distribution queue 302A-302n using the parameter information; in some embodiments, for example, the Web server will determine the appropriate carrier distribution queue by mapping the data identifying the carrier and time zone into a corresponding extended_carrier_ID, and then search through appropriate carrier distribution queue comparing the timestamps of the queued events with the timestamp of the most current event received from the tuner. All of the queued events, therefore, that have timestamps later in time to the timestamp of the most current event on the tuner are thereafter in the next stage 294 sent to the tuner by the Web server 104.

In some embodiments, any general-purpose Web server 104 may be used to implement the various embodiments of the presenting invention. In some embodiments, for example, Web server 104 includes the Microsoft Internet Information Server 5.5, manufactured by Microsoft Corporation of Redmond, Washington, executing within a Microsoft 2000 Server operating environment, also manufactured by Microsoft Corporation. In some embodiments, application logic for the processes described in reference to FIGS. 9A-9B are coded as one or more Java servlets. In some embodiments, the servlets are executed within a commercial servlet container (not shown), such as the BEA Weblogic 5.1 application server, manufactured by BEA Corporation of San Jose, Calif. Web server 104 thus processes HTTP requests received from the client computers 116 by invoking servlet processes from the application server. The Weblogic application server additionally includes built-in distributed processing, load-balancing, and clustering capabilities enabling a Web server cluster to be efficiently created from individual Web servers. The use of servlets and servlet containers for coding Web server logic is well-known to those skilled in the art. Additional information describing the use and operation of Java servlet and BEA Weblogic application server technologies are available over the Internet at http://www.sun.com and http://www.bea.com respectively.

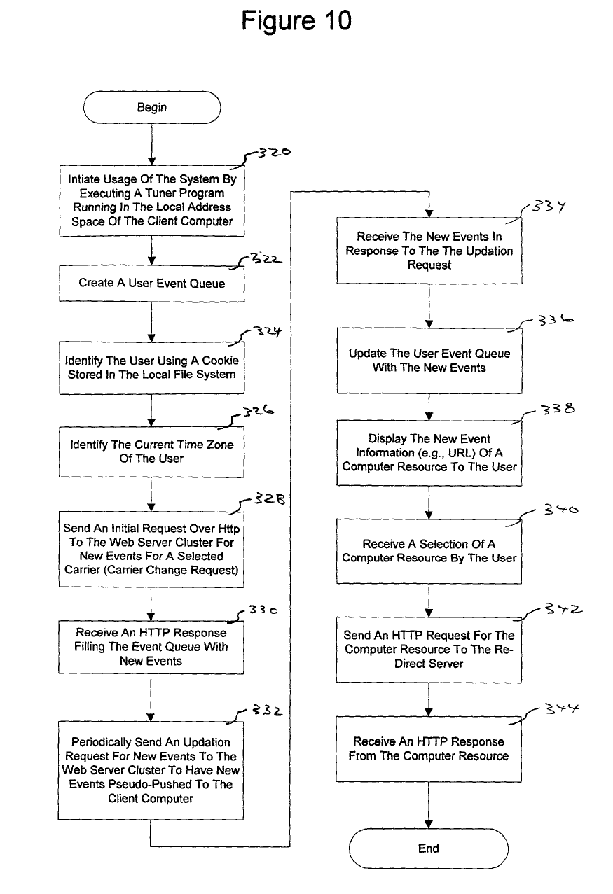

FIG. 10 is a flow diagram illustrating in more detail the process stages performed by the client computer, according to some embodiments of the present invention. Stage 320-330 describe processes performed by the client computer 116 upon access to the System 100 by a user. Stages 332-344 describes processes performed by the client computer 116 after it has accessed the System 100. In stage 320, a user initiates usage of the System 100 via the client computer 116 by executing a small program (hereafter “tuner” or “tuner program”) (not shown) in the local address space of the client computer 116. The tuner may be made available for execution by the user using a number of conventional techniques. For example, in one embodiment, the tuner may be uploaded as an applet into the client computer 116 from the Web server cluster in response to an initial HTTP request to access the System 100; in another embodiment, the tuner may be downloaded via the computer network 98 as a binary file for stand-alone execution within a particular operating environment, such as a Microsoft Windows operating environment; in yet another embodiment, the tuner may be coded in Javascript, embedded in the HTML pages, and processed by a Java-enabled Web browser (i.e., Java Virtual Machine) during processing of the HTML pages. In general, the tuner program must be capable of establishing data communication with the Web server cluster using conventional Web communication protocols (i.e., HTTP over TCP/IP using, typically, public port 80).

In stage 322, the tuner program creates a user event queue. In stage 324, the tuner program identifies the user using a conventional cookie file previously stored in the local file system of the client computer 116; in some embodiments, the user is identified by the user's email address previously submitted by the user during a registration process. If a cookie is not found, the cookie may at this stage be re-created using data stored in the database server 106; if no data (e.g., the user's email address) is stored in the database server 106 identifying the user, then the user may be required to enter a registration process with the System 100 for collection of this information. In stage 326, the tuner program identifies the time zone of the user as identified in the cookie. In stage 328, the tuner program sends a carrier change request to the Web server cluster 104 over computer network 98 using HTTP. The tuner sends a carrier change request either upon initial access to the System 100 or in response to a user selection to receive events from a different carrier. The carrier change request includes data identifying the user time zone and a user selected carrier; in some embodiments, a default carrier may be predetermined for the initial carrier change request. In stage 330, the tuner program receives a response from the Web server cluster 104 which includes the latest events required to populate the user event queue for the carrier specified by the user (or as specified by default by the tuner program) in the previous stage.

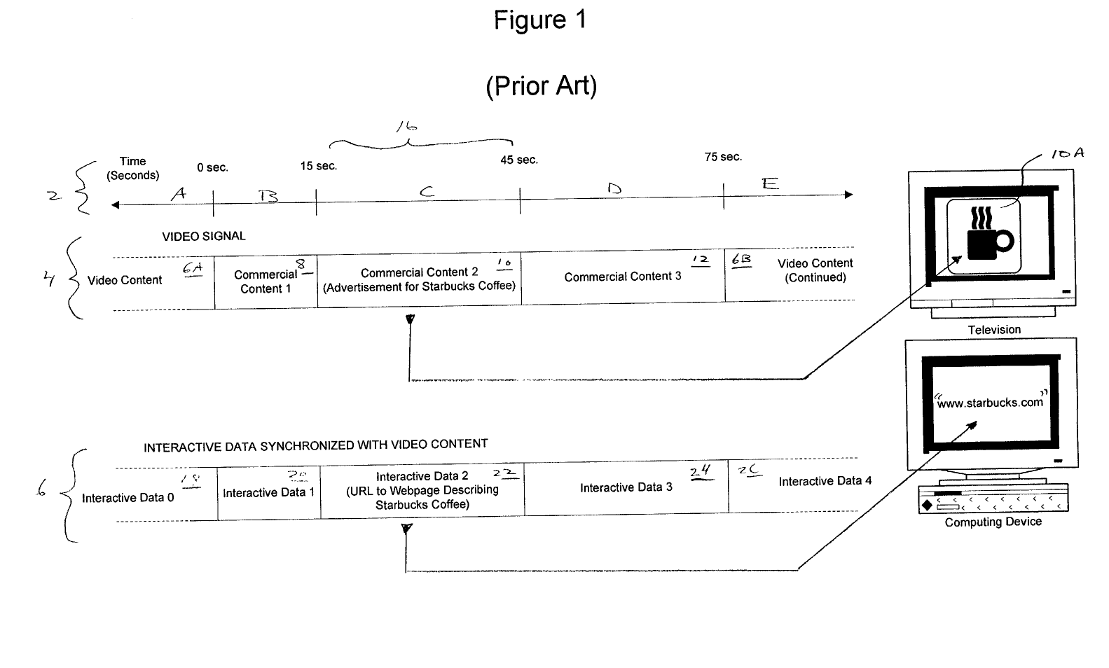

After initial execution of the tuner program, then in stage 332 the tuner program periodically sends an updation request over HTTP to the Web server cluster 104 to receive relevant new events. The periodic requests sent by the tuner program are hidden from the user and enable the System 100 to distribute new events 220 to the user in pseudo-push fashion. In some embodiments, the updation requests are sent by each client computer every 7.5 seconds. In these embodiments, 7.5 seconds represents the Nyquist sampling frequency (generally half of the duration of the minimum target sample) for a 15-second video signal constituting the typically shortest commercial advertisement used by carriers, e.g., commercial content 1 in 15-second time interval B (FIG. 1). The updation request period however may be adjusted to any time interval depending upon a number of factors, e.g., the particular video content (live events for game shows may require short intervals—users may be “participating” in the game show in real-time using a remote computer resource), and the bandwidth limitations of the System 100 (millions of users sending requests over a short period of time may congest the Web server cluster's 104 ability to process the requests), among other considerations. In stage 334, the tuner program receives the new events 220 in response to the updation request.

In stage 336, the tuner program updates the user event queue with the newly received event 220. In stage 338, the tuner program displays the new events to the user, as, for example, illustrated in FIG. 3. In stage 340, the tuner program receives a selection of a remote computer resource (via, e.g., selection of a hyperlink encoded with the URL for the remote computer resource), such as network server 130 (FIG. 4) by the user. In stage 342, the tuner program sends an HTTP re-direct request to the re-direct server 108 which includes the location of the (typically remote) computer resource (i.e., the URL of the computer resource) selected by the user. A conventional Web browser (not illustrated) running on the client computer then receives the response directly from the selected remote computer resource by the user. The Web browser may include Internet Explorer, manufactured by Microsoft Corporation of Redmond, Wash., or Netscape Navigator, manufactured by Netscape Communications Corporation of Mountain View, Calif.

The re-direct server 108 includes a conventional Web server programmed to collect information relating to user activities in response to event selections, and to store the information in the database server 106. User activity information stored in the database server 106 includes a record of each re-direct request, including the location of the selected remote computer resource and the IP address of the client computer 116 used by the user. The user activities collected by the re-direct server 108 enables—in conjunction with profile information collected from the user during, e.g., a user registration process—enables the System 100 owner to generates reporting information supporting customer relationship management, decision-making and other business needs of the owner.

Distribution server 102, Web server cluster 104, and re-direct server 108 communicate with database server 106 using conventional techniques. Database server 106 is hosted by any suitable general-purpose server computer well-known to those skilled in the art, such as the Caliber CP2700, manufactured by Caliber Corporation of Fremont, Calif. Any robust commercial database management system software may be used to implement database 106. In some embodiments, the database management system software includes Microsoft SQL Server Version 7.0 manufactured by Microsoft Corporation. Network communication with the database server 108 by the distribution server 102, Web server cluster 104, and re-direct server 108 is performed using appropriate database driver software loaded into to the distribution server 102, Web server cluster 104, and re-direct server 108 respectively. Appropriate database drivers for Microsoft SQL may be downloaded from the Internet at http://www.microsoft.com.

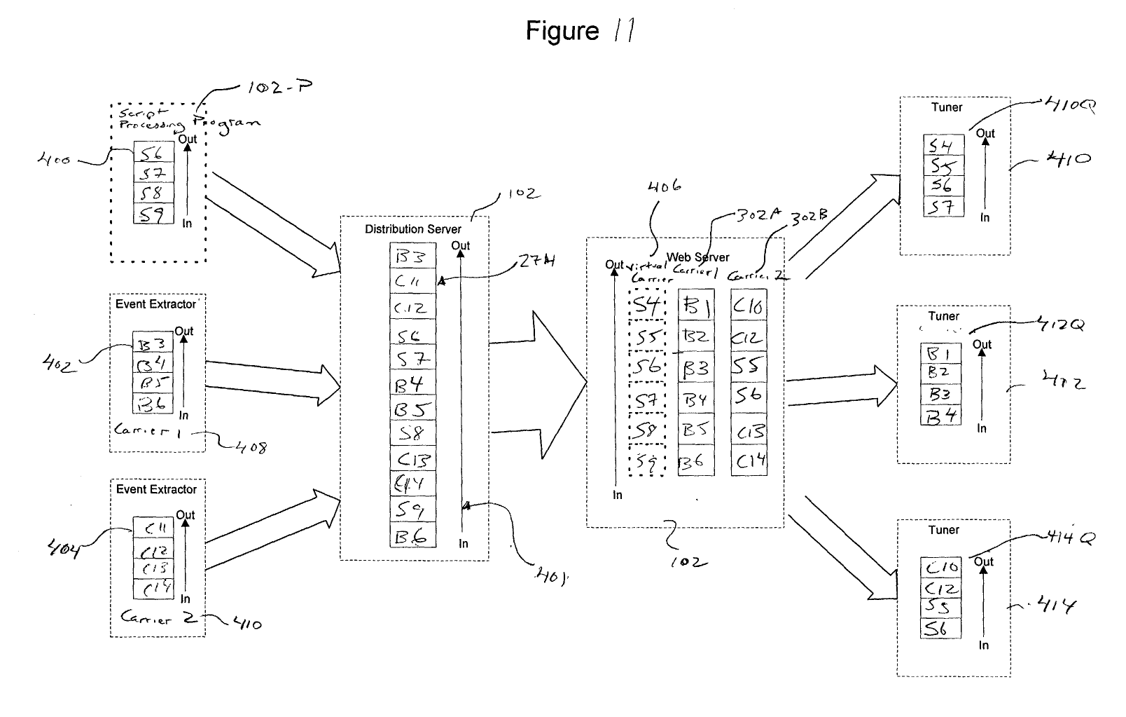

FIG. 11 is a flow diagram illustrating the processing of script links by the System 100, according to some embodiments of the present invention. In some embodiments, script link processing by the System 100 is accomplished using software having a front-end component and a back-end component. In some embodiments, the front-end component includes a script event generation program (hereafter “event generation program”) 102-E (FIG. 5A) uploaded into a conventional Web server 102-W hosted on computer 102 (i.e., along with the distribution server 102. Web server 102-W may, however, be hosted on any properly interconnected and configured server computer. The event generation program 102-E provides a Web-based interface for access by an interactive data producer 122 via a client computer 116 (FIG. 4) over the computer network 98. The event generation program 102-E generates a series of webpages enabling the interactive data producer 122 to enter one or more individual script events for automatic assembly into a script file readable by the back-end script component. The event generation program 102-E also enables a user to submit an already assembled script file containing a series of script events for processing by the back-end component.

In some embodiments, the back-end component includes a script processing program 102-P uploaded into the distribution server enabling the distribution server to distribute events assembled in a properly formatted script file. In particular, in some embodiments, distribution server 102 spawns a script directories management thread 440 which checks the headers of pending script files (stored, e.g., in the local file system of the host computer) to determine the time when they are to be distributed to the client computers 116. When a script file is determined to be ready for distribution, the script directories management thread 440 spawns a script process thread 442 to retrieve the script events from the script file. The script directories management thread 440 then posts the script links retrieved from the script file to the central distribution queue 274. The script directories management thread 440 additionally notifies the recordation thread 290 to store a record of the script event activities within the database server 106.

FIG. 12 is a block diagram illustrating the processing of script events in combination with live events by the System 100, according to some embodiments of the present invention. An exemplary portion of a script file 400 is illustrated containing five script events S6-S9. Portions of two exemplary series of live events are also illustrated: a first portion 402 received from a carrier 1 408, and a second portion 404 received from a carrier 2 410. Each portion 402-404 includes live events B3-B6 and C11-C14 respectively. Distribution server 102 receives live events 402-404 from live event source computers 112, and receives script events 400 from script processing program 102-P executing within the distribution server 102. Distribution server stores the processed script events 400 and the live events 402-404 in the central distribution queue 274, and then broadcasts the stored events 400-404 to the Web server cluster 104. In general, the Web server cluster 104 and tuner programs 410 process the script events and live events identically. Accordingly, depending on how the script events are identified in the script file—i.e., in some embodiments by extended carrier ID-the Web server cluster 104 will appropriately send the script event to the appropriate corresponding carrier distribution queue, e.g., 302A, in accordance with stage 286 (FIG. 9B). As additionally illustrated by “virtual” carrier queue 406 in Web server 104, one or more “virtual carriers” can be created and maintained by the System 100 (the virtual carrier is, e.g., assigned a unique extended carrier ID 222). A virtual carrier as used herein refers to a “carrier” of script events unrelated to any contemporaneous performance of video or other content. Note that although virtual script events are non-synchronous, script events can be created to be synchronized with video content. This is illustrated by carrier queue 302B—in which script events S5 and S6 were created to be included within the series of live events 404 between the occurrences of C12 and C13; this is additionally illustrated by user distribution queue 414 containing script events S5 and S6 already distributed to the user client computer 116.

Although various embodiments of the invention have been shown and described, the invention is limited only by the following claims.

We claim:

1. A computer-implemented method for distributing interactive data to a plurality of users over a computer network, the method comprising:
processing a series of the interactive data, the interactive data being synchronized with a performance of audio-visual content; and
distributing the interactive data to the plurality of users over the computer network, wherein the distributing is synchronized with the contemporaneous performance of the audio-visual content.

2. The method of claim 1, wherein the audio-visual content includes audio-only content, visual-only content, and combined audio and visual content.

3. The method of claim 1, wherein the audio-visual content is received via a broadcast signal.

4. The method of claim 1, wherein the interactive data includes an interactive event.

5. The method of claim 1, wherein the interactive data includes a link to a remote computer resource.

6. The method of claim 5, wherein the link includes a URL.

7. The method of claim 5, wherein the link includes a label describing the remote computer resource.

8. The method of claim 1, wherein the interactive data includes information identifying a broadcast signal by carrier.

9. The method of claim 4, further comprising:
recording the interactive events in a computer storage medium.

10. The method of claim 1, further comprising:
uploading the series into at least one Web server.

11. The method of claim 1, further comprising:
extracting the series from a broadcast transmission.

12. The method of claim 4, wherein each interactive event is marked with a timestamp at the moment of the extracting.

13. The method of claim 12, further comprising:
receiving a plurality of event updation requests from the plurality of client computers over the computer network; and
performing the distributing for a particular client computer in response to receiving an updation request from the particular client computer.

14. The method of claim 13, further comprising:
wherein the event updation request received from the particular client computer includes information identifying the most current interactive event received by the particular client computer;
determining whether any of the interactive events in the uploaded series is more current than the interactive event identified in the event updation request; and
if a more current interactive event in the uploaded series is identified, distributing the identified interactive event to the particular client computer.

15. The method of claim 14, further comprising:
if more than one interactive event in the uploaded series is determined to be more current than the interactive event identified in the event updation request, distributing the next most current interactive event in the uploaded series to the particular client computer.

16. The method of claim 4, further comprising:
receiving a selection of one of the distributed interactive events from a particular client computer, wherein the selection identifies information retrievable from a server computer connected to the computer network.

17. The method of claim 16, further comprising:
storing a record of the selection in a computer storage medium.

18. The method of claim 16, further comprising:
receiving the selection as an HTTP command sent by a Web browser executing in the particular client computer.

19. The method of claim 16, further comprising:
sending a request for the information identified by the selection to the server computer identified by the selection, wherein the request includes an instruction directing the server computer to send the linked information to the particular client computer.

20. The method of claim 1, further comprising:
receiving multiple series of interactive events over the computer network, wherein each series is embedded in a different live broadcast signal; and
distributing each series to a portion of the plurality of users over the computer network, wherein the distributing for each series is synchronized with the corresponding live broadcast signal originating the respective series.

21. The method of claim 20, further comprising:
determining which portion of the plurality of users to distribute a particular series based on a request received from each of the plurality of users, wherein each request identifies the particular series to be distributed to the requesting user.

22. The method of claim 20, further comprising:
uploading each series of interactive events into a plurality of Web servers within a Web server cluster.

23. The method of claim 1, further comprising:
generating the series via execution of a computer program.

24. The method of claim 23, wherein the computer program is a scripting program.

25. The method of claim 1, further comprising:
generating at least one interactive event; and
distributing the event to at least one of the plurality of users, wherein the event is inserted within the series of interactive television events.

26. The method of claim 25, wherein the generating includes executing a scripting program.

27. The method of claim 25, further comprising:
receiving a selection of the generated event from a particular client computer, wherein the selected generated event identifies information retrievable from a server computer connected to the computer network.

28. The method of claim 27, storing a record of the selection in a database.

29. The method of claim 27, wherein the selection is received as an HTTP command sent by a Web browser executing in the particular client computer.

30. The method of claim 27, further comprising:
sending a request for the information identified by the selection to the server computer identified by the selection, wherein the request includes an instruction directing the server computer to send the linked information to the particular client computer.

31. A computer system for distributing a series of interactive television events to a plurality of users over a computer network, the method comprising:
a first computer connected to the computer network;
a first computer program executing in the first computer, the first computer program including computer instructions for:
receiving the series of interactive events over the computer network, wherein the series is embedded in a live broadcast signal; and
sending the series to at least one second computer;
the second computer connected to the first computer and to at least one client computer via the computer network;
a second computer program executing in the second computer, the second computer program including computer instructions for:
receiving the series of interactive events from the first computer; and
sending the series to the client computer in response to a request received from the client computer.

32. The computer system of claim 31, further comprising:
a third computer connected to the first computer; and
a third computer program executing in the third computer, the computer program including computer instructions for:
extracting a series of interactive events from a live broadcast signal; and
sending the series to the first computer.

33. The computer system of claim 31, further comprising:
a fourth computer connected to the client computer via the computer network; and
a fourth computer program executing in the fourth computer, the fourth computer program including computer instructions for:
receiving a selection of one of the distributed interactive events from a particular client computer, wherein the selection identifies information retrievable from a server computer connected to the computer network; and
sending a request for the information identified by the selection to the server computer identified by the selection, wherein the request includes an instruction directing the server computer to send the linked information to the particular client computer.

34. The computer system of claim 31, further comprising:
a fourth computer program executing in the first computer, the fourth computer program including computer instructions for:
generating an interactive event;
inserting the generated interactive event within the series; and
sending the series with the inserted event to the second computer.
